(19) United States
(12) Patent Application Publication
(10) Pub. No.: US 2022/0276655 A1
(43) Pub. Date: Sep. 1, 2022

(54) INFORMATION PROCESSING DEVICE, INFORMATION PROCESSING METHOD, AND PROGRAM

(71) Applicant: SONY GROUP CORPORATION, TOKYO (JP)

(72) Inventors: RYO TAKAHASHI, TOKYO (JP); KEISUKE MAEDA, TOKYO (JP)

(21) Appl. No.: 17/635,155

(22) PCT Filed: Aug. 7, 2020
(86) PCT No.: PCT/JP2020/030309

§ 371 Date: Feb. 14, 2022

(30) Foreign Application Priority Data
Aug. 21, 2019 (JP) 2019-150917

(51) Int. Cl. G05D 1/02; G05D 1/00

(52) U.S. Cl. CPC G05D 1/0214; G05D 1/0088; G05D 1/0274; G05D 1/0238; G05D 2201/0207

(57) ABSTRACT

The present disclosure relates to an information processing device, an information processing method, and a program for reducing a calculation time in track planning for autonomous traveling. A plurality of track candidates among track candidates sampled in sampling-based track planning is integrated, a track mask in which the plurality of integrated track candidates and each grid of an occupancy grid map are associated with each other is generated, and collision determination of the track candidates is performed on the basis of the generated track mask and the occupancy grid map. The present disclosure can be applied to a mobile body.

### TECHNICAL FIELD

The present disclosure relates to an information processing device, an information processing method, and a program, and more particularly to an information processing device, an information processing method, and a program for shortening a calculation time in track planning for autonomous traveling.

### BACKGROUND ART

In many cases, an autonomous mobile body travels while collecting surrounding obstacle information on an occupancy grid map. The occupancy grid map is a table in which a moving space in the real world including the mobile body is divided into grid-like cells and the presence or absence of an obstacle is expressed for each cell.

In movement to a destination, the autonomous mobile body travels while sequentially calculating a movement route in which the mobile body does not collide with an obstacle and performs a feasible and favorable motion in terms of a motion model for the mobile body.

The movement route is a “sequence of position, attitude, and speed to be present at each time” drawn in a physical space, and in particular, a route adding time is referred to as a track.

Among countless possible tracks, a problem is limited under a constraint that “satisfying the motion model without colliding with an obstacle”, and a track that satisfies an evaluation criterion of “favorable” is selected as a target track from among the tracks. The track planning is considered to be one of such optimization problems.

Not to collide with an obstacle, it is necessary to obtain information from the above-described occupancy grid map and use the information for planning. Since a positional relationship between the mobile body and the obstacle can change with the movement of the autonomous mobile body itself or the movement of the obstacle, it is required to perform track planning sufficiently fast for collision avoidance.

Without sufficient consideration of the constraint by the motion model, no matter how desirably the target track is generated, the autonomous mobile body may not be able to move on the target track in the real world.

However, if a complex motion model is assumed too much, calculation of the optimization problem becomes complicated and the amount of calculation increases.

The desirability of movement is expressed as some evaluation function depending on a situation or an application required for the autonomous mobile body.

The track planning is required to be continuously solved every hour at a high speed to such an extent as to implement the obstacle avoidance.

However, it is rare to analytically obtain the target track that is an optimal solution of an optimization problem constrained by a dense motion model, and it is often necessary to adopt a more time-consuming numerical search method in reality.

Sampling-based track planning is known as one of such methods. The sampling-based track planning is that obtaining an optimal solution in a target track planning problem is abandoned, instead, a plurality of candidate tracks is generated in advance, and “one in which the motion body does not collide with an obstacle and which has the highest evaluation value” in the candidates is adopted as an approximately optimal track.

In the sampling-based track planning, only track candidates considering the motion model at a previous track sampling time point are taken into account. Furthermore, it is important to adjust the sampling track to be generated to be “favorable” from the beginning in order to enable good movement.

By taking the sampling-based track planning approach, it is possible to select a target track while approximately solving an optimization problem within a predetermined time.

However, even in the sampling-based track planning, the number of samplings need to be increased in order to select a better track, and measures for reducing a calculation time are required to improve performance.

Therefore, as one of the methods for reducing the calculation time in the sampling-based track planning, a technique of sequentially evaluating sampled track candidates and terminating the evaluation thereafter when finding a track whose evaluation value falls below a reference value, and adopting the candidate as a target track (see Patent Document 1).

In this technology, an optimum candidate is not selected from all the candidates, but it is possible to reduce the amount of calculation by making a compromise in a moderate manner.

### CITATION LIST

### Patent Document

Patent Document 1: Japanese Patent Application Laid-Open No. 2018-95149

### SUMMARY OF THE INVENTION

### Problems to be Solved by the Invention

However, although the technique of Patent Document 1 is a highly versatile method, the approximation of the optimization problem may become coarser depending on the selection of the reference value, and there is a possibility of reducing movement performance when moving on the adopted target track.

The present disclosure has been made in view of such a situation, and in particular suppresses degradation in movement performance when moving on a target track and shortens a calculation time by reducing the calculation time without roughening approximation of an optimization problem in sampling-based track planning.

### Solutions to Problems

An information processing device and a program according to one aspect of the present disclosure are an information processing device and a program including: a track candidate sampling unit configured to sample a track candidate of a mobile body; a track mask generation unit configured to integrate a plurality of the track candidates, of the track candidates sampled by the track candidate sampling unit, in association with a grid of an occupancy grid map, and generate a track mask in which the plurality of integrated track candidates and the grid of the occupancy grid map are associated with each other; and a collision determination unit configured to perform collision determination of the track candidates on the basis of the track mask generated by the track mask generation unit and the occupancy grid map.

An information processing method according to one aspect of the present disclosure is an information processing method including: track candidate sampling processing of sampling a track candidate of a mobile body; track mask generation processing of integrating a plurality of the track candidates, of the track candidates sampled by the track candidate sampling processing, in association with a grid of an occupancy grid map, and generating a track mask in which the plurality of integrated track candidates and the grid of the occupancy grid map are associated with each other; and collision determination processing of performing collision determination of the track candidates on the basis of the track mask generated by the track mask generation processing and the occupancy grid map.

In one aspect of the present disclosure, track candidates of a mobile body are sampled, a plurality of the track candidates among the sampled track candidates is integrated in association with a grid of an occupancy grid map, a track mask in which the plurality of integrated track candidates and the grid of the occupancy grid map are associated with each other is generated, and collision determination of the track candidates is performed on the basis of the generated track mask and the occupancy grid map.

### BRIEF DESCRIPTION OF DRAWINGS

FIG. 1 is a diagram for describing an outline of the present disclosure.

FIG. 2 is a diagram for describing a configuration example of a vehicle control system to which the present disclosure is applied.

FIG. 3 is a diagram for describing a configuration example of a track planning unit in FIG. 2.

FIG. 4 is a diagram for describing a track mask.

FIG. 5 is a diagram for describing a track mask.

FIG. 6 is a diagram for describing an example of collision determination part 1.

FIG. 7 is a flowchart for describing track planning processing.

FIG. 8 is a flowchart for describing collision determination processing part 1.

FIG. 9 is a diagram for describing an example of collision determination part 2.

FIG. 10 is a flowchart for describing collision determination processing part 2.

FIG. 11 is a diagram for describing an example of collision determination part 2.

FIG. 12 is a flowchart for describing collision determination processing part 2.

FIG. 13 is a diagram illustrating a configuration example of a general-purpose computer.

### MODE FOR CARRYING OUT THE INVENTION

A favorable embodiment of the present disclosure will be described in detail with reference to the appended drawings. Note that, in the present specification and drawings, redundant description of configuration elements having substantially the same functional configuration is omitted by providing the same sign.

Hereinafter, modes for carrying out the present technology will be described. Description will be given in the following order.

1. Outline of Present Disclosure

2. First Embodiment

3. Second Embodiment

4. Third Embodiment

5. Example of Executed by Software

### 1. Outline of Present Disclosure

The present disclosure is to reduce a calculation time without roughening approximation of an optimization problem in sampling-based track planning.

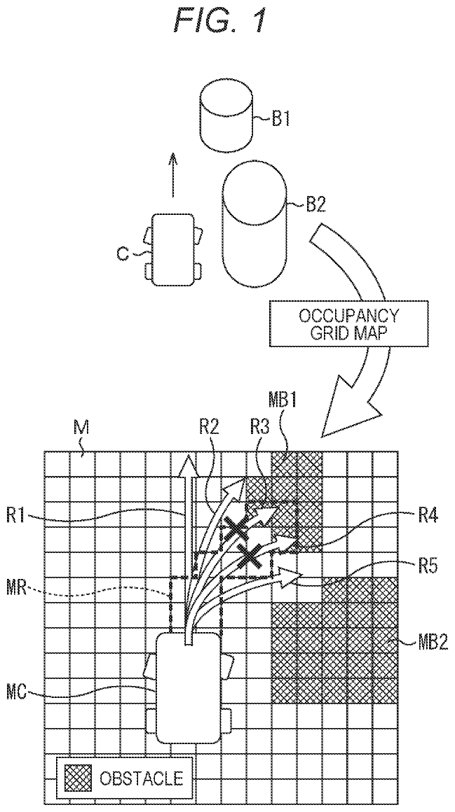

First, an outline of the present disclosure will be described with reference to FIG. 1.

For example, as illustrated in the upper part of FIG. 1, it is assumed that a vehicle C, which is an autonomous mobile body, travels upward in the drawing in the vicinity of obstacles B1 and B2.

At this time, the vehicle C acquires an occupancy grid map (occupancy map) M as illustrated in the lower part of FIG. 1 by a stereo camera or a distance sensor such as light detection and ranging or laser imaging detection and ranging (LiDAR) (not illustrated) provided in the vehicle C.

The occupancy grid map M is a map in which a space movable by the vehicle C is divided into grid-like cellular grids, and the presence or absence of an obstacle is expressed for each grid.

In the lower part of FIG. 1, a position of an object is expressed for each area in which a surrounding space when the vehicle C is viewed from above is expressed by grids, and areas MB1 and MB2 respectively represent areas where the obstacles B1 and B2 are present. Note that the vehicle C is expressed as an area MC irrelevant to the grids.

At this time, the vehicle C samples track candidates R1 to R5 in the sampling-based track planning.

The track candidates to be actually sampled are not limited to R1 to R5 and an infinite number of track candidates may be present between R1 and R5. However, in the conventional methods, collision determination with respect to obstacles on the occupancy grid map M has been performed for each of the track candidates.

As described above, in the sampling track planning, if the number of track candidates is large, the amount of calculation increases, the calculation time becomes long, and it may not be practically usable. Therefore, it is necessary to reduce the amount of calculation as described in Patent Document 1.

Therefore, in the present disclosure, among a plurality of sampled track candidates, track candidates at close positions are integrated in units of grids on an occupancy grid map, a track mask corresponding to the occupancy grid map is set, the track mask in which the plurality of track candidates is integrated and the occupancy grid map are superimposed, and collision determination is performed by collation between the track mask and an obstacle on the occupancy grid map.

For example, in the case of the lower part of FIG. 1, a track mask MR for integrating the track candidates R3 and R4 as indicated by the dotted lines is set in the grids through which the track candidates R3 and R4 pass, and is superimposed on the occupancy grid map.

Then, the collision is determined according to whether or not the area of the dotted track mask MR overlaps with an obstacle on the occupancy grid map. Thereby, the collision determination with respect to the obstacles on the track candidates R3 and R4 integrated in the area of the track mask MR can be simultaneously implemented.

That is, in the case of FIG. 1, the collision determination is performed with respect to the track mask MR, so that a collision with the area MB1 is determined. Therefore, it is determined that the track candidates R3 and R4 cannot be set as the target tracks by the one calculation.

That is, by integrating a plurality of track candidates in units of grids and setting the integrated track candidates as a track mask, superimposing the track mask on the occupancy grid map, and performing the collision determination with respect to an obstacle for each track mask, the amount of calculation can be reduced as compared with a case of performing collision determination with respect to an obstacle for each of the track candidates.

As a result, since it is not necessary to change a determination criterion or the like related to the collision determination in order to reduce the amount of calculation, it is possible to implement high-precision collision determination at high speed.

### 2. First Embodiment

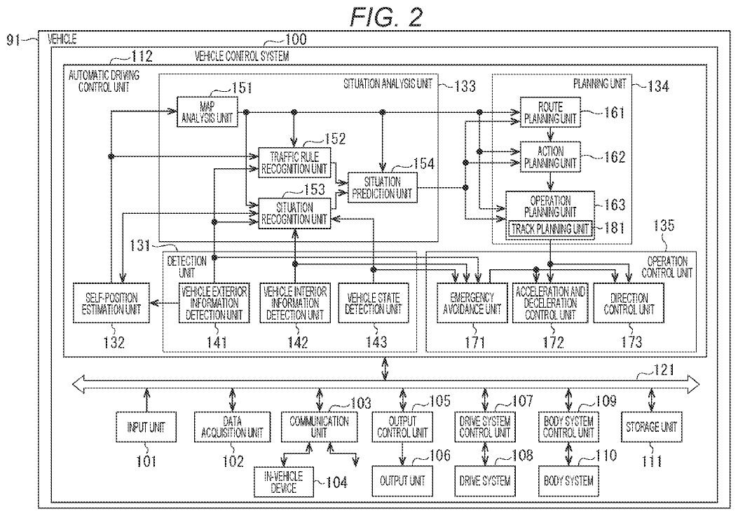

FIG. 2 is a block diagram illustrating a schematic functional configuration example of a vehicle control system 100 of a vehicle 91 as an example of a mobile body control system to which the present technology is applicable.

FIG. 1 is a block diagram illustrating a schematic functional configuration example of a vehicle control system 100 as an example of a mobile body control system to which the present technology is applicable.

Note that, hereinafter, in a case of distinguishing the vehicle provided with the vehicle control system 100 from other vehicles, the vehicle will be referred to as user's car or user's vehicle.

The vehicle control system 100 includes an input unit 101, a data acquisition unit 102, a communication unit 103, an in-vehicle device 104, an output control unit 105, an output unit 106, a drive system control unit 107, a drive system 108, a body system control unit 109, a body system 110, a storage unit 111, and an automatic driving control unit 112. The input unit 101, the data acquisition unit 102, the communication unit 103, the output control unit 105, the drive system control unit 107, the body system control unit 109, the storage unit 111, and the automatic driving control unit 112 are connected to one another via a communication network 121. The communication network 121 includes, for example, an on-board communication network conforming to an arbitrary standard such as a controller area network (CAN), a local interconnect network (LIN), a local area network (LAN), or FlexRay (registered trademark), a bus, and the like. Note that the units of the vehicle control system 100 may be directly connected without the communication network 121.

Note that, hereinafter, the case where the units of the vehicle control system 100 perform communication via the communication network 121, the description of the communication network 121 is omitted. For example, the case where the input unit 101 and the automatic driving control unit 112 perform communication via the communication network 121 will be simply described as the input unit 101 and the automatic driving control unit 112 performing communication.

The input unit 101 includes a device used by a passenger to input various data, instructions, and the like. For example, the input unit 101 includes operation devices such as a touch panel, a button, a microphone, a switch, and a lever, an operation device capable of inputting data, instructions, and the like by a method other than a manual operation, such as voice or gesture, and the like. Furthermore, for example, the input unit 101 may be a remote control device using infrared rays or other radio waves, or an externally connected device such as a mobile device or a wearable device corresponding to the operation of the vehicle control system 100. The input unit 101 generates an input signal on the basis of the data, instructions, and the like input by the passenger, and supplies the input signal to each unit of the vehicle control system 100.

The data acquisition unit 102 includes various sensors and the like that acquire data to be used for the processing of the vehicle control system 100, and supplies the acquired data to each unit of the vehicle control system 100.

For example, the data acquisition unit 102 includes various sensors for detecting the state of the user's car and the like. Specifically, for example, the data acquisition unit 102 includes a gyro sensor, an acceleration sensor, an inertial measurement device (IMU), sensors for detecting an operation amount of an accelerator pedal, an operation amount of a brake pedal, a steering angle of a steering wheel, an engine speed, a motor speed, a rotation speed of wheels, or the like, and the like.

Furthermore, for example, the data acquisition unit 102 includes various sensors for detecting information outside the user's car. Specifically, for example, the data acquisition unit 102 includes imaging devices such as a time of flight (ToF) camera, a stereo camera, a monocular camera, an infrared camera, and other cameras. Furthermore, for example, the data acquisition unit 102 includes an environment sensor for detecting a weather, a meteorological phenomenon, or the like, and ambient information detection sensors for detecting an object around the user's car. The environment sensor includes, for example, a raindrop sensor, a fog sensor, a sunshine sensor, a snow sensor, and the like. The ambient information detection sensors include, for example, an ultrasonic sensor, a radar device, a light detection and ranging or laser imaging detection and ranging (LiDAR) device, a sonar, and the like.

Moreover, the data acquisition unit 102 includes, for example, various sensors for detecting a current position of the user's car. Specifically, for example, the data acquisition unit 102 includes a global navigation satellite system (GNSS) receiver that receives a GNSS signal from a GNSS satellite.

Furthermore, for example, the data acquisition unit 102 includes various sensors for detecting information inside the vehicle. Specifically, for example, the data acquisition unit 102 includes an imaging device that images a driver, a biosensor that detects biometric information of the driver, a microphone that collects sound in a vehicle interior, and the like. The biosensor is provided, for example, on a seating surface, a steering wheel, or the like, and detects the biometric information of a passenger sitting on a seat or the driver holding the steering wheel.

The communication unit 103 communicates with the in-vehicle device 104 and various devices outside the vehicle, a server, a base station, and the like, transmits data supplied from each unit of the vehicle control system 100, and supplies received data to each unit of the vehicle control system 100. Note that a communication protocol supported by the communication unit 103 is not especially limited, and the communication unit 103 can support a plurality of types of communication protocols.

For example, the communication unit 103 performs wireless communication with the in-vehicle device 104, using a wireless LAN, Bluetooth (registered trademark), near field communication (NFC), a wireless USB (WUSB), or the like. Furthermore, for example, the communication unit 103 performs wired communication with the in-vehicle device 104, using a universal serial bus (USB), a high-definition multimedia interface (HDMI, registered trademark), a mobile high-definition link (MHL), or the like via a connection terminal (not illustrated) (and a cable if necessary).

Moreover, for example, the communication unit 103 communicates with a device (for example, an application server or a control server) existing on an external network (for example, the Internet, a cloud network, or a company specific network) via a base station or an access point. Furthermore, for example, the communication unit 103 communicates with a terminal (for example, a terminal of a pedestrian or a shop, or a machine type communication (MTC) terminal) existing in the vicinity of the user's car, using a peer to peer (P2P) technology. Moreover, for example, the communication unit 103 performs V2X communication such as vehicle to vehicle communication, vehicle to infrastructure communication, vehicle to home communication, and vehicle to pedestrian communication. Furthermore, for example, the communication unit 103 includes a beacon reception unit, and receives a radio wave or an electromagnetic wave transmitted from a wireless station or the like installed on a road, and acquires information such as a current position, congestion, traffic regulation, or required time.

The in-vehicle device 104 includes, for example, a mobile device or a wearable device of a passenger, an information device carried in or attached to the user's vehicle, a navigation device for searching for a route to an arbitrary destination, and the like.

The output control unit 105 controls output of various types of information to the passenger of the user's car or to the outside of the vehicle. The output control unit 105 controls output of visual information (for example, image data) and auditory information (for example, sound data) from the output unit 106 by generating an output signal including at least one of the visual information or the auditory information and supplying the output signal to the output unit 106, for example. Specifically, for example, the output control unit 105 synthesizes image data captured by different imaging devices of the data acquisition unit 102 to generate a bird's-eye view image, a panoramic image, or the like, and supplies an output signal including the generated image to the output unit 106. Furthermore, for example, the output control unit 105 generates sound data including a warning sound, a warning message, or the like for dangers of collision, contact, entry to a dangerous zone, or the like and supplies an output signal including the generated sound data to the output unit 106.

The output unit 106 includes a device capable of outputting the visual information or the auditory information to the passenger of the user's car or to the outside of the vehicle. For example, the output unit 106 includes a display device, an instrument panel, an audio speaker, headphones, a wearable device such as a glasses-type display worn by the passenger, a projector, a lamp, or the like. The display device included in the output unit 106 may be, for example, a head-up display, a transmission-type display, or a display for displaying the visual information in a field of view of the driver, such as a device having an augmented reality (AR) display function, in addition to a device having a normal display.

The drive system control unit 107 controls the drive system 108 by generating various control signals and supplying the control signals to the drive system 108. Furthermore, the drive system control unit 107 supplies a control signal to each unit other than the drive system 108 to issue notification of a control state of the drive system 108, or the like, as needed.

The drive system 108 includes various devices related to the drive system of the user's car. For example, the drive system 108 includes a drive force generation device for generating a drive force of an internal combustion engine or a drive motor, a drive force transmission mechanism for transmitting the drive force to the wheels, a steering mechanism for adjusting the steering angle, a braking device for generating a braking force, an antilock brake system (ABS), an electronic stability control (ESC), an electric power steering device, and the like.

The body system control unit 109 controls the body system 110 by generating various control signals and supplying the control signals to the body system 110. Furthermore, the body system control unit 109 supplies a control signal to each unit other than the body system 110 and issues notification of a control state of the body system 110, or the like, as needed.

The body system 110 includes various body-system devices mounted on a vehicle body. For example, the body system 110 includes a keyless entry system, a smart key system, a power window device, a power seat, a steering wheel, an air conditioner, various lamps (for example, headlights, backlights, brake lights, blinkers, fog lights, and the like), and the like.

The storage unit 111 includes, for example, a magnetic storage device such as a read only memory (ROM), a random access memory (RAM), and a hard disc drive (HDD), a semiconductor storage device, an optical storage device, a magneto-optical storage device, and the like. The storage unit 111 stores various programs, data, and the like used by each unit of the vehicle control system 100. For example, the storage unit 111 stores map data such as a three-dimensional high-precision map such as a dynamic map, a global map having less accuracy than the high-precision map but covering a large area, and a local map including information around the user's car.

The automatic driving control unit 112 performs control related to the automatic driving such as autonomous traveling or driving assist. Specifically, for example, the automatic driving control unit 112 performs cooperative control for the purpose of implementing an advanced driver assistance system (ADAS) function including collision avoidance or shock mitigation of the user's car, following travel based on a vehicular gap, vehicle speed maintaining travel, collision warning of the user's car, lane out warning of the user's car, and the like. Furthermore, for example, the automatic driving control unit 112 performs the cooperative control for the purpose of automatic driving and the like of autonomous travel without depending on an operation of the driver. The automatic driving control unit 112 includes a detection unit 131, a self-position estimation unit 132, a situation analysis unit 133, a planning unit 134, and an operation control unit 135.

The detection unit 131 detects various types of information necessary for controlling the automatic driving. The detection unit 131 includes a vehicle exterior information detection unit 141, a vehicle interior information detection unit 142, and a vehicle state detection unit 143.

The vehicle exterior information detection unit 141 performs processing of detecting information outside the user's car on the basis of data or signals from each unit of the vehicle control system 100. For example, the vehicle exterior information detection unit 141 performs detection processing, recognition processing, and tracking processing, for an object around the user's car, and processing of detecting a distance to the object. Objects to be detected include, for example, vehicles, people, obstacles, structures, roads, traffic lights, traffic signs, road markings, and the like. Furthermore, for example, the vehicle exterior information detection unit 141 performs processing of detecting an environment around the user's car. The surrounding environment to be detected includes, for example, weather, temperature, humidity, brightness, road surface condition, and the like. The vehicle exterior information detection unit 141 supplies data indicating results of the detection processing to the self-position estimation unit 132, a map analysis unit 151, a traffic rule recognition unit 152, and a situation recognition unit 153 of the situation analysis unit 133, and an emergency avoidance unit 171 and the like of the operation control unit 135.

The vehicle interior information detection unit 142 performs processing of detecting information inside the vehicle on the basis of data or signals from each unit of the vehicle control system 100. For example, the vehicle interior information detection unit 142 performs driver authentication processing and recognition processing, driver state detection processing, passenger detection processing, vehicle interior environment detection processing, and the like. The state of the driver to be detected includes, for example, a physical condition, an arousal level, a concentration level, a fatigue level, a line-of-sight direction, or the like. The environment in the vehicle to be detected includes, for example, temperature, humidity, brightness, odor, and the like. The vehicle interior information detection unit 142 supplies data indicating results of the detection processing to the situation recognition unit 153 of the situation analysis unit 133, the emergency avoidance unit 171 of the operation control unit 135, and the like.

The vehicle state detection unit 143 performs processing of detecting the state of the user's car on the basis of data or signals from each unit of the vehicle control system 100. The state of the user's car to be detected includes, for example, a speed, an acceleration, a steering angle, presence or absence of abnormality, content of abnormality, a state of driving operation, position and tilt of a power seat, a state of door lock, a state of another in-vehicle device, or the like. The vehicle state detection unit 143 supplies data indicating results of the detection processing to the situation recognition unit 153 of the situation analysis unit 133, the emergency avoidance unit 171 of the operation control unit 135, and the like.

The self-position estimation unit 132 performs processing of estimating the position, posture, and the like of the user's car on the basis of the data or signals from the units of the vehicle control system 100 such as the vehicle exterior information detection unit 141 and the situation recognition unit 153 of the situation analysis unit 133. Furthermore, the self-position estimation unit 132 generates a local map (hereinafter referred to as self-position estimation map) to be used for estimating the self-position, as needed. The self-position estimation map is a high-precision map using a technology such as simultaneous localization and mapping (SLAM), or the like. The self-position estimation unit 132 supplies data indicating a result of the estimation processing to the map analysis unit 151, the traffic rule recognition unit 152, and the situation recognition unit 153 of the situation analysis unit 133, and the like. Furthermore, the self-position estimation unit 132 causes the storage unit 111 to store the self-position estimation map.

The situation analysis unit 133 performs processing of analyzing the situation of the user's car and its surroundings. The situation analysis unit 133 includes the map analysis unit 151, the traffic rule recognition unit 152, the situation recognition unit 153, and a situation prediction unit 154.

The map analysis unit 151 performs processing of analyzing various maps stored in the storage unit 111, using the data or signals from the units of the vehicle control system 100 such as the self-position estimation unit 132 and the vehicle exterior information detection unit 141, as needed, and builds a map including information necessary for automatic driving processing. The map analysis unit 151 supplies the built map to the traffic rule recognition unit 152, the situation recognition unit 153, the situation prediction unit 154, and a route planning unit 161, an action planning unit 162, and an operation planning unit 163 of the planning unit 134, and the like.

The traffic rule recognition unit 152 performs processing of recognizing a traffic rule around the user's car on the basis of the data or signals from the units of the vehicle control system 100 such as the self-position estimation unit 132, the vehicle exterior information detection unit 141, and the map analysis unit 151. By the recognition processing, for example, the position and state of signals around the user's car, the content of traffic regulation around the user's car, a travelable lane, and the like are recognized. The traffic rule recognition unit 152 supplies data indicating a result of the recognition processing to the situation prediction unit 154 and the like.

The situation recognition unit 153 performs processing of recognizing the situation regarding the user's car on the basis of the data or signals from the units of the vehicle control system 100 such as the self-position estimation unit 132, the vehicle exterior information detection unit 141, the vehicle interior information detection unit 142, the vehicle state detection unit 143, and the map analysis unit 151. For example, the situation recognition unit 153 performs processing of recognizing a situation of the user's car, a situation around the user's car, a situation of the driver of the user's car, and the like. Furthermore, the situation recognition unit 153 generates a local map (hereinafter referred to as situation recognition map) used for recognizing the situation around the user's car, as needed. The situation recognition map is, for example, an occupancy grid map.

The situation of the user's car to be recognized includes, for example, the position, attitude, movement (for example, speed, acceleration, moving direction, and the like) of the user's car, and the presence or absence and content of abnormality, and the like. The situation around the user's car to be recognized includes, for example, types and positions of surrounding stationary objects, types of surrounding moving objects, positions and motions (for example, speed, acceleration, moving direction, and the like), configurations of surrounding roads and conditions of road surfaces, as well as surrounding weather, temperature, humidity, brightness, and the like. The state of the driver to be recognized includes, for example, physical condition, arousal level, concentration level, fatigue level, line-of-sight motion, traveling operation, and the like.

The situation recognition unit 153 supplies the data indicating a result of the recognition processing (including the situation recognition map, as needed) to the self-position estimation unit 132, the situation prediction unit 154, and the like. Furthermore, the situation recognition unit 153 causes the storage unit 111 to store the situation recognition map.

The situation prediction unit 154 performs processing of predicting the situation regarding the user's car on the basis of the data or signals from the units of the vehicle control system 100 such as the map analysis unit 151, the traffic rule recognition unit 152, and the situation recognition unit 153. For example, the situation prediction unit 154 performs processing of predicting the situation of the user's car, the situation around the user's car, the situation of the driver, and the like.

The situation of the user's car to be predicted includes, for example, a behavior of the user's car, occurrence of abnormality, a travelable distance, and the like. The situation around the user's car to be predicted includes, for example, a behavior of a moving object around the user's car, a change in a signal state, a change in the environment such as weather, and the like. The situation of the driver to be predicted includes, for example, a behavior and physical conditions of the driver, and the like.

The situation prediction unit 154 supplies data indicating a result of the prediction processing together with the data from the traffic rule recognition unit 152 and the situation recognition unit 153 to the route planning unit 161, the action planning unit 162, the operation planning unit 163 of the planning unit 134, and the like.

The route planning unit 161 plans a route to a destination on the basis of the data or signals from the units of the vehicle control system 100 such as the map analysis unit 151 and the situation prediction unit 154. For example, the route planning unit 161 sets a route to a destination specified from a current position on the basis of the global map. Furthermore, for example, the route planning unit 161 appropriately changes the route on the basis of situations of congestion, accidents, traffic regulations, construction, and the like, the physical conditions of the driver, and the like. The route planning unit 161 supplies data indicating the planned route to the action planning unit 162 and the like.

The action planning unit 162 plans an action of the user's car for safely traveling in the route planned by the route planning unit 161 within a planned time on the basis of the data or signals from the units of the vehicle control system 100 such as the map analysis unit 151 and the situation prediction unit 154. For example, the action planning unit 162 makes a plan of starting, stopping, traveling directions (for example, forward, backward, turning left, turning right, turning, and the like), driving lane, traveling speed, passing, and the like. The action planning unit 162 supplies data indicating the planned action of the user's car to the operation planning unit 163 and the like.

The operation planning unit 163 plans an operation of the user's car for implementing the action planned by the action planning unit 162 on the basis of the data or signals from the units of the vehicle control system 100 such as the map analysis unit 151 and the situation prediction unit 154. For example, the operation planning unit 163 plans acceleration, deceleration, a traveling track, and the like. The operation planning unit 163 supplies data indicating the planned operation of the user's car to an acceleration and deceleration control unit 172 and a direction control unit 173 of the operation control unit 135, and the like.

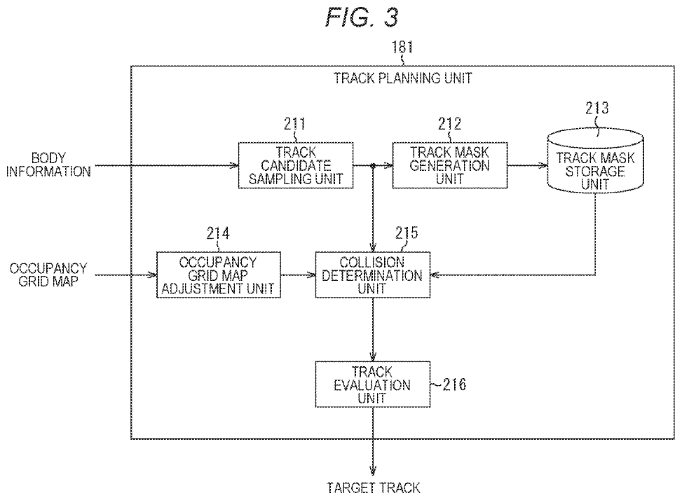

More specifically, the operation planning unit 163 includes a track planning unit 181. The track planning unit 181 plans a traveling track (target track) by sampling track planning based on data or signals from each unit of the vehicle control system 100 such as the map analysis unit 151 and the situation prediction unit 154. Note that a detailed configuration of the track planning unit 181 will be described below in detail with reference to FIG. 3.

The operation control unit 135 controls the operation of the user's car. The operation control unit 135 includes the emergency avoidance unit 171, the acceleration and deceleration control unit 172, and the direction control unit 173.

The emergency avoidance unit 171 performs processing of detecting an emergency situation such as collision, contact, entry into a dangerous zone, driver's abnormality, vehicle's abnormality, and the like on the basis of the detection results of the vehicle exterior information detection unit 141, the vehicle interior information detection unit 142, and the vehicle state detection unit 143. In a case where the emergency avoidance unit 171 detects occurrence of the emergency situation, the emergency avoidance unit 171 plans the operation of the user's car for avoiding the emergency situation, such as sudden stop or sharp turn. The emergency avoidance unit 171 supplies data indicating the planned operation of the user's car to the acceleration and deceleration control unit 172, the direction control unit 173, and the like.

The acceleration and deceleration control unit 172 performs acceleration and deceleration for implementing the operation of the user's car planned by the operation planning unit 163 or the emergency avoidance unit 171. For example, the acceleration and deceleration control unit 172 calculates a control target value of a drive force generation device or a braking device for implementing the planned acceleration, deceleration, or sudden stop, and supplies a control command indicating the calculated control target value to the drive system control unit 107.

The direction control unit 173 controls a direction for implementing the operation of the user's car planned by the operation planning unit 163 or the emergency avoidance unit 171. For example, the direction control unit 173 calculates a control target value of a steering mechanism for implementing the traveling track or sharp turn planned by the operation planning unit 163 or the emergency avoidance unit 171, and supplies a control command indicating the calculated control target value to the drive system control unit 107.

<Configuration Example of Track Planning Unit>

Next, a configuration example of the track planning unit 181 will be described with reference to the block diagram of FIG. 3.

The track planning unit 181 includes a track candidate sampling unit 211, a track mask generation unit 212, a track mask storage unit 213, an occupancy grid map adjustment unit 214, a collision determination unit 215, and a track evaluation unit 216.

The track candidate sampling unit 211 samples track candidates in consideration of a motion model of the vehicle 91 on the basis of body information including a posture and surrounding information of the vehicle 91 supplied from each unit of the vehicle control system 100 such as the map analysis unit 151 and the situation prediction unit 154 of the situation analysis unit 133.

Then, the track candidate sampling unit 211 outputs information of the sampled track candidates to the track mask generation unit 212 and the collision determination unit 215.

When sampling the tracks, the track candidate sampling unit 211 samples the track candidates in consideration of a resolution of the occupancy grid map adjusted by the occupancy grid map adjustment unit 214.

The track mask generation unit 212 generates a track mask for integrating a plurality of track candidates in units of square-shaped grids corresponding to the occupancy grid map on the basis of the track candidates supplied from the track candidate sampling unit 211, and causes the track mask storage unit 213 to store the track mask as a correspondence table indicating a relationship between the grids on which the track mask is formed and the corresponding track candidates.

In other words, the track mask generation unit 212 forms an area of grids as the track mask by integrating a plurality of track candidates among the grids corresponding to the occupancy grid map, generates the correspondence table indicating the relationship between the grids on which the track mask is formed and the corresponding tracks, and causes the track mask storage unit 213 to store the correspondence table as track mask information.

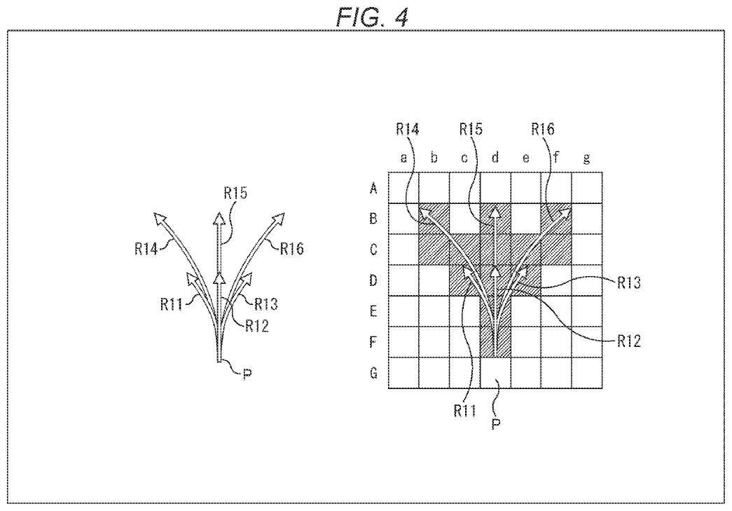

More specifically, for example, as illustrated in the left part of FIG. 4, it is assumed that the track candidate sampling unit 211 samples track candidates R11 to R16 according to the posture and surrounding situation from a current position P of the vehicle 91, and outputs the sampled track candidates to the track mask generation unit 212 and the collision determination unit 215.

At this time, as illustrated in the right part of FIG. 4, when setting the square-shaped grids corresponding to the occupancy grid map for the track candidates R11 to R16 with reference to the position of the vehicle 91, the track mask generation unit 212 integrates the track candidates passing through the grids to set the track mask.

Note that the positions of the grids in FIG. 4 are represented by symbols a to g in a horizontal direction and symbols A to G in a vertical direction. For example, the position P of the vehicle 91 is represented as a hatched square-shaped grid (d, G) in FIG. 4.

That is, in the right part of FIG. 4, the grids (d, F), (d, E), (d, D), and (c, D) through which the track candidate R11 passes are set as a corresponding track mask.

Furthermore, the grids (d, F), (d, E), (d, D), (c, D), (c, C), (b, C), and (b, B) through which the track candidate R14 passes are set as a corresponding track mask.

Here, since the grids (d, F), (d, E), (d, D), and (c, D) are common to the track candidates R11 and R14, the grids are integrally set as a track mask.

Similarly, the grids (d, F), (d, E), and (d, D) through which the track candidate R12 passes are set as a corresponding track mask.

Furthermore, the grids (d, F), (d, E), (d, D), (d, C), and (d, B) through which the track candidate R15 passes are set as a track mask.

Here, since the grids (d, F), (d, E), and (d, D) are common to the track candidates R11, R12, R14, and R15, the grids are integrally set as a track mask.

Similarly, the grids (d, F), (d, E), (d, D), and (e, D) through which the track candidate R13 passes are set as a corresponding track mask.

Furthermore, the grids (d, F), (d, E), (e, D), (e, C), (f, C), and (f, B) through which the track candidate R16 passes are set as a track mask.

Here, since the grids (d, F), (d, E), (d, D), and (e, D) are common to the track candidates R11 and R16, the grids are integrally set as a track mask.

Moreover, since the grids (d, E), (d, D), and (e, D) are common to all the track candidates R11 to R16, the grids are integrally set as a track mask.

The track mask generation unit 212 causes the track mask storage unit 213 to store the track mask set as described with reference to FIG. 4 as a table that associates the grids set as the track mask with the corresponding track candidates.

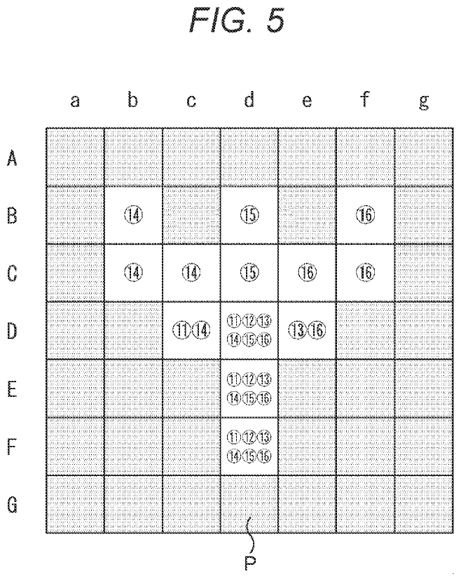

For example, the track masks set as illustrated in FIG. 4 are stored as the correspondence table as illustrated in FIG. 5.

That is, since the grids (d, E), (d, D), and (d, C) are set as a track mask because all the track candidates R11 to R16 pass through the grids, the track mask generation unit 212 registers that the grids (d, E), (d, D), and (d, C) are set as a track mask in which the track candidates R11 to R16 are integrated.

Note that, in FIG. 5, numbers 11 to 16 corresponding to the track candidates R11 to R16 passing through the grids are written in the circles in the grids set as the track masks.

Furthermore, since the grid (c, D) is set as a track mask because the track candidates R11 and R14 pass through the grid, the track mask generation unit 212 registers that the grid (c, D) is set as a track mask in which the track candidates R11 and R14 are integrated.

Moreover, since the grid (e, D) is set as a track mask because the track candidates R13 and R16 pass through the grid, the track mask generation unit 212 registers that the grid (e, D) is set as a track mask of the track candidates R13 and R16.

Furthermore, since the grids (c, C), (b, C), and (c, B) are set as a track mask because the track candidate R14 passes through the grids, the track mask generation unit 212 registers that the grids (c, C), (b, C), and (c, B) are set as a track mask of the track candidate R14.

Moreover, since the grids (d, C) and (d, B) are set as a track mask because the track candidate R15 passes through the grids, the track mask generation unit 212 registers that the grids (d, C) and (d, B) are set as a track mask of the track candidate R15.

Moreover, since the grids (e,C), (f, C), and (f, B) are set as a track mask because the track candidate R16 passes through the grids, the track mask generation unit 212 registers that the grids (e, C), (f, C), and (f, B) are set as a track mask of the track candidate R16.

The track mask storage unit 213 stores the track masks as information as the correspondence table illustrated in FIG. 5.

Here, description returns to the block diagram of FIG. 3.

When acquiring the occupancy grid map generated by the situation recognition unit 153 of the situation analysis unit 133, the occupancy grid map adjustment unit 214 adjusts the resolution so as to correspond to a grid interval of a track mask, and outputs the resolution to the collision determination unit 215. The resolution of the occupancy grid map herein is substantially a grid size. That is, the occupancy grid map adjustment unit 214 adjusts the grid size of the occupancy grid map and the grid size for which the track mask is set so as to correspond to each other.

The collision determination unit 215 determines the presence or absence of collision with an obstacle on the occupancy grid map in units of the track mask on the basis of the occupancy grid map with the resolution adjusted so as to correspond to the grid interval of the track mask supplied from the occupancy grid map adjustment unit 214, the track candidates, and the track mask, and outputs the track candidate without collision to the track evaluation unit 216.

More specifically, the collision determination unit 215 performs collision determination according to the presence or absence of an obstacle on the occupancy grid map on the track mask by superimposing the occupancy grid map and the track mask.

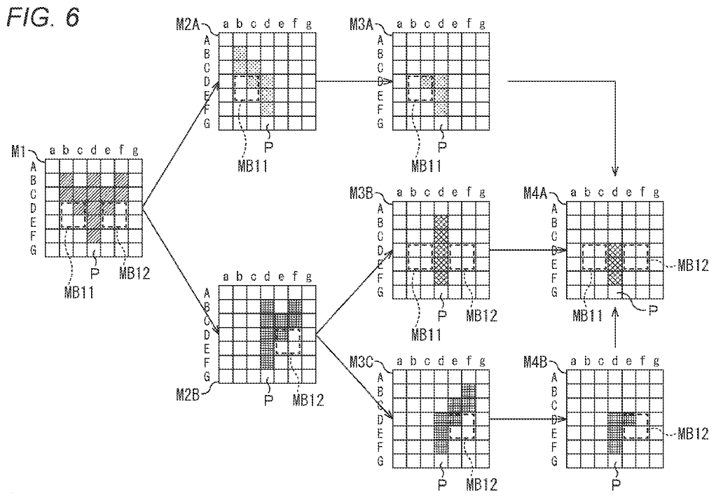

More specifically, when the occupancy grid map is superimposed on a track mask M1 illustrated in the left part of FIG. 6 corresponding to the track mask of FIG. 4, for example, it is assumed that obstacles are present in an area MB11 including the grids (b, D), (b, E), (c, D), and (c, E) and an area MB12 including the grids (e, D), (e, E), (f, D), and (f, E) illustrated by the dotted lines.

In such a case, there are obstacles in the areas MB11 and MB12, respectively, on the track mask M1 of FIG. 6, and collision will occur in the grids (c, D) and (e, D) on the track mask M1. Therefore, the collision determination unit 215 determines that there is collision.

Note that, in a case where the above-described areas MB11 and MB12 are not present on the track mask M1 of FIG. 6, there are no obstacles on the track mask M1, so it is determined that there is no collision, and all the track candidates R11 to R16 included in the track mask M1 are selected as track candidates without collision and output to the track evaluation unit 216.

Furthermore, in a case where obstacles are present on the track mask M1 and it is determined that there is collision, the collision determination unit 215 divides the track mask M1 into, for example, track masks M2A and M2B, and performs collision determination similar to the above description for each of the divided track masks.

That is, the collision determination unit 215 divides the track mask M1 in units of track masks in which the track candidates are integrated.

More specifically, as illustrated in FIG. 6, the collision determination unit 215 divides the track mask M1 into the track mask M2A in which the track candidates R11, R12, and R14 are integrated and the track mask M2B in which the track candidates R12, R13, R15, and R16 are integrated. That is, the collision determination unit 215 sequentially subdivides the track mask until it is determined that there is no collision.

Here, in a case where there are no obstacles in the areas MB11 and MB12 in the track mask M2A, it is determined that there is no collision, and the track candidates R11, R12, and R14 integrated into the track mask M2A are output to the track evaluation unit 216.

Furthermore, in a case where the area MB11 is present in the track mask M2A and it is determined that there is collision, the collision determination unit 215 extracts a track mask M3A in which the track candidates R11 and R12 close to the current position are integrated among the track candidates R11, R12, and R14 integrated into the track mask M2A, and performs the collision determination.

That is, the collision determination unit 215 sequentially subdivides the track mask until it is determined that there is no collision, and extracts a track mask in which track candidates in a range close to the current position are integrated when simple subdivision cannot be performed, and performs collision determination.

This is for, for example, gradually performing collision determination of a track candidate group in a close range by extracting the track mask M3A in which the track candidates R11 and R12 at positions close to the current position P are integrated, from the track mask M2A in which the track candidates R11, R12, and R14 are integrated.

That is, the subdivision of the track mask determined to have collision is not only simply subdividing the track mask but also extracting a track mask in which track candidates in a range close to the current position are integrated.

For example, here, in a case where it is determined that there is no obstacle in the area MB11 and there is no collision, for the track mask M3A, the collision determination unit 215 outputs the track candidates R11, R12, and R14 of the track mask M3A to the track evaluation unit 216.

Furthermore, in a case where it is determined that there is an obstacle in the area MB11 and there is collision, for the track mask M3A, the collision determination unit 215 further subdivides the track mask M3A and extracts a track mask M4A of FIG. 6 because all of the track candidates R11, R12, and R14 integrated into the track mask M3A are considered to have collision.

Since the track mask M4A does not interfere with any obstacle in the areas MB11 and MB12 on the occupancy grid map, it is determined that there is no collision, and only the corresponding track candidate R12 is output to the track evaluation unit 216.

Meanwhile, in the track mask M2B, for example, in a case where the area MB12 is not present, it is determined that there is no collision, and the collision determination unit 215 outputs R12, R13, R15, and R16 integrated in the track mask M2B to the track evaluation unit 216.

Furthermore, in the track mask M2B, for example, in a case where an obstacle is present in the area MB12 on the occupancy grid map, it is determined that there is collision, and the collision determination unit 215 divides the track mask M2B into a track mask M3B in which the track candidates R12 and R15 are integrated and a track mask M3C in which the track candidates R12, R13, and R16 are integrated, as illustrated in FIG. 6.

Then, in a case where collision determination is similarly performed and it is determined that there is no collision, the track candidates R12 and R15 or R12, R13, and R16 integrated into each of the track masks M3B and M3C are output to the track evaluation unit 216.

Furthermore, in a case where it is determined that there is collision for the track mask M3B, the collision determination unit 215 extracts the track mask M4A corresponding to the track candidate R12 with the track mask close to the current position P among the track candidates R12 and R15 of the track mask M3B, and performs collision determination.

Moreover, similarly, in a case where it is determined that there is collision for the track mask M3C, the collision determination unit 215 extracts the track mask M4B corresponding to the track candidates R12 and R13 with the track mask close to the current position among the track candidates R12, R13, and R16 of the track mask M3C, and performs collision determination.

Here, if there is no collision, the track candidates R12 and R13 are output to the track evaluation unit 216, or if there is collision, the track mask M4A corresponding to the track candidate R12 close to the current position P is extracted from the track mask M3C and collision determination is performed.

Note that, in a case where the track mask M4A has interference with some obstacle on the occupancy grid map and it is determined that there is collision, there is no track candidate without collision. Therefore, the track evaluation unit 216 is notified that there is no track candidate without collision.

The track evaluation unit 216 sets an evaluation value for each of the track candidates that are determined to have no collision by the collision determination unit 215, and selects and outputs a track candidate with the highest evaluation as a target track.

For example, the track evaluation unit 216 calculates an evaluation value obtained by scoring evaluation of each track candidate such as a travel distance, a travel speed, stability of behavior, and fuel consumption when the vehicle 91 travels on each of the track candidates without collision, sets the track candidate having the highest calculated evaluation value as the target track, and outputs the target track.

With the above configuration, even when a plurality of track candidates is set, collision determination is not performed for each of the track candidates, but collision determination with respect to the occupancy grid map is performed in units of a track mask (in units of grids constituting the track mask) in which a plurality of track candidates is integrated.

As a result, the amount of calculation related to the collision determination can be reduced, and the processing speed related to the collision determination can be improved.

<Track Planning Processing>

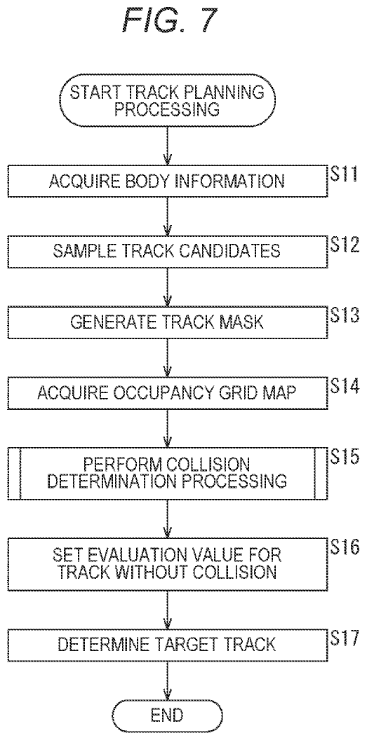

Next, track planning processing by the track planning unit 181 in FIG. 2 will be described with reference to a flowchart in FIG. 7.

In step S11, the track candidate sampling unit 211 acquires the body information including a posture and surrounding information of the vehicle 91 and the like supplied from the map analysis unit 151, the situation prediction unit 154, and the like of the situation analysis unit 133.

In step S12, the track candidate sampling unit 211 samples the track candidates on the basis of the acquired body information, and outputs the track candidates to the track mask generation unit 212.

In step S13, as described above with reference to FIG. 5, the track mask generation unit 212 generates the track mask on the basis of the sampled track candidates, and causes the track mask storage unit 213 to store the track mask as the correspondence table of the grids and the track candidates.

In step S14, the occupancy grid map adjustment unit 214 acquires the occupancy grid map generated by the situation recognition unit 153 of the situation analysis unit 133, adjusts the resolution of the occupancy grid map, and outputs the occupancy grid map to the collision determination unit 215.

In step S15, the collision determination unit 215 executes the collision determination processing on the basis of the track mask information stored in the track mask storage unit 213, the occupancy grid map supplied from the occupancy grid map adjustment unit 214, and the information of the track candidates supplied from the track candidate sampling unit 211, and determines the presence or absence of collision with an obstacle in units of track masks. Then, the collision determination unit 215 outputs, to the track evaluation unit 216, the track candidate without collision integrated into the track mask without collision on the basis of the determination result.

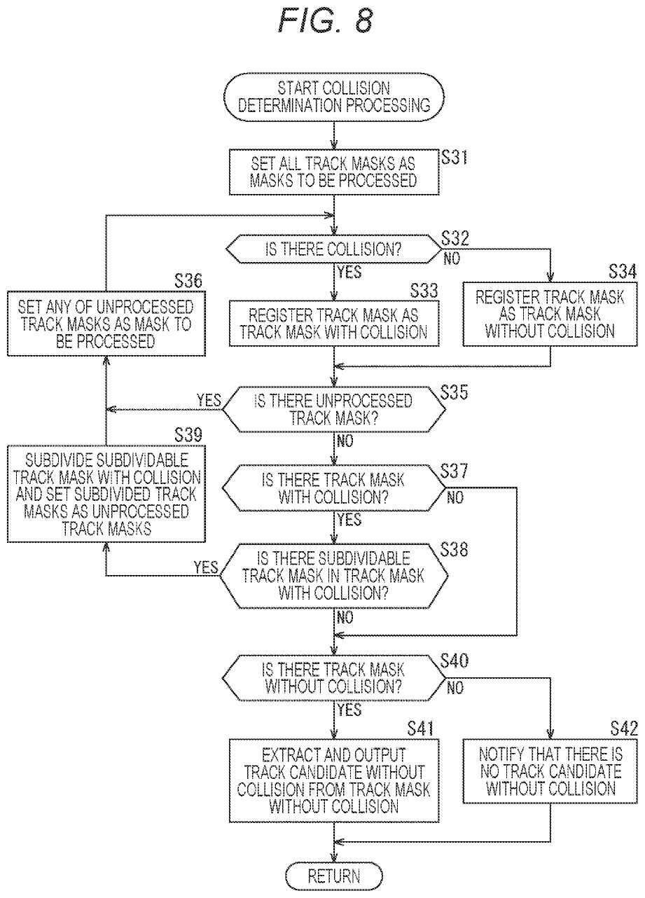

Note that details of the collision determination processing will be described below with reference to the flowchart in FIG. 8.

In step S16, the track evaluation unit 216 calculates an evaluation value obtained by scoring the evaluation of each track candidate such as a travel distance, a travel speed, stability of behavior, and fuel consumption in the case where the vehicle travels on each track candidate, for example, for the track candidate without collision supplied from the collision determination unit 215.

In step S17, the track evaluation unit 216 sets the track candidate having the highest calculated evaluation value as the target track and outputs the target track.

Through the above-described series of processing, the track candidate having a high evaluation value among the track candidates is planned and output as the target track.

Note that, in a case where it is a notification that there is no track candidate without collision is transmitted by the collision determination processing in step S15, a notification of the track candidate without collision is not transmitted in step S16. Therefore, the track evaluation unit 216 cannot set the evaluation value.

Therefore, in this case, in step S17, the track evaluation unit 218 notifies the user by voice, image, or the like of absence of the track candidate without collision.

<Collision Determination Processing (Part 1)>

Next, collision determination processing in the track planning unit 181 in FIG. 3 will be described with reference to the flowchart in FIG. 8.

In step S31, the collision determination unit 215 reads the track mask information from the track mask storage unit 213 and sets all the track masks as track masks to be processed.

In step S32, the collision determination unit 215 superimposes the track mask set as the track mask to be processed on the occupancy grid map, and determines the presence or absence of collision according to whether or not there is an obstacle on the occupancy grid map on the track mask.

In step S32, for example, in the track mask M1 described with reference to FIG. 6, in a case where there are obstacles as indicated by the areas MB11 and MB12 and the presence of collision is determined, the processing proceeds to step S33.

In step S33, the collision determination unit 215 registers that the track mask to be processed is in the presence of collision. That is, here, all the track masks are registered as the presence of collision, as indicated by the track mask M1 in FIG. 6.

Furthermore, in step S32, in a case where the absence of collision is determined, the processing proceeds to step S34.

In step S34, the collision determination unit 215 registers that the track mask to be processed is in the absence of collision. That is, here, all the track masks are registered as the absence of collision, as indicated by the track mask M1 in FIG. 6.

In step S35, the collision determination unit 215 determines whether or not there is an unprocessed track mask.

For example, in a case where the track mask to be processed is the track mask M1, since there is no other unprocessed track mask, it is assumed that there is no unprocessed track mask, and the processing proceeds to step S37.

In step S37, the collision determination unit 215 determines whether or not there is a track mask registered with the presence of collision.

In step S37, for example, in the case where the track mask M1 in FIG. 6 is registered as the presence of collision, there is a track mask with collision, and thus the processing proceeds to step S38.

In step S38, the collision determination unit 215 determines whether or not there is a subdividable track mask in the track mask with collision.

In step S38, for example, since the track mask M1 to be processed in FIG. 6 can be subdivided into the track masks M2A and M2B, the presence of a subdividable track mask is determined, and the processing proceeds to step S39.

In step S39, the collision determination unit 215 subdivides the subdividable track mask with collision and sets the subdivided track masks as unprocessed track masks.

That is, for example, the collision determination unit 215 subdivides the track mask M1 into track masks M2A and M2B, and sets the subdivided track masks M2A and M2B as unprocessed track masks.

In step S36, the collision determination unit 215 sets one of the unprocessed track masks as the track mask to be processed, and the processing returns to step S32.

Then, when the collision determination of the track mask to be processed is performed by the processing in steps S32 to S34, in a case where there is an unprocessed track mask in step S35, the processing returns to step S36 and a new unprocessed track mask is set as the track mask to be processed, and the subsequent processing is repeated.

That is, the processing of steps S32 to S36 is repeated until the presence or absence of collision is determined for all of the subdivided track masks.

Then, when the presence or absence of collision is determined for all the subdivided track masks, the absence of an unprocessed track mask is determined in step S35, and the processing proceeds to step S37.

As long as there is a track mask with collision in step S37 and there is a subdividable track mask in the track mask with collision in step S38, the processing of steps S32 to S39 is repeated, and the subdivision of the track mask and the determination of the presence or absence of collision of the subdivided track mask are repeated.

Then, in step S37, in a case where there is no track mask with collision, that is, for example, in a case where there is no collision in the case where the track mask to be processed is the track mask M1, the processing proceeds to step S40.

Alternatively, in a case where there is a track mask with collision in step S37 but there is no subdividable track mask in step S38, the processing proceeds to step S40.

In step S40, the collision determination unit 215 determines whether or not there is a track mask without collision.

In step S40, in the case where there is a track mask without collision, the processing proceeds to step S41.

In step S41, the collision determination unit 215 outputs the track candidate integrated into the track mask without collision to the track evaluation unit 216.

Furthermore, in step S40, in the case where there is no track mask without collision, the processing proceeds to step S42.

In step S42, the collision determination unit 215 notifies the track evaluation unit 216 that there is no track without collision.

By the above-described series of processing, the collision determination unit 215 determines the presence or absence of collision in units of track masks in which track candidates are integrated, and thus, it is possible to reduce the amount of calculation and to select a track candidate at a higher speed than the processing of determining collision for each track candidate.

### 3. Second Embodiment

In the above description, an example in which the collision determination is sequentially performed for all the track masks in units of track masks in which the track candidates are integrated, and in a case where there is collision, the track mask is gradually subdivided, and the processing of determining the presence or absence of collision is repeated has been described.

However, the method of determining the presence or absence of collision for all the track masks and subdividing the track mask in the case where there is collision can greatly reduce the amount of calculation when there are few tracks having collision. However, in a case where there are many tracks having collision, the processing of subdividing the track mask and determining the presence or absence of collision increases, and thus there is a possibility that the reduction in the amount of calculation cannot be expected.

Therefore, collision determination may be performed from a smallest track mask, the collision determination may be performed while gradually expanding the track mask, and presence or absence of collision of all the track masks may be finally determined.

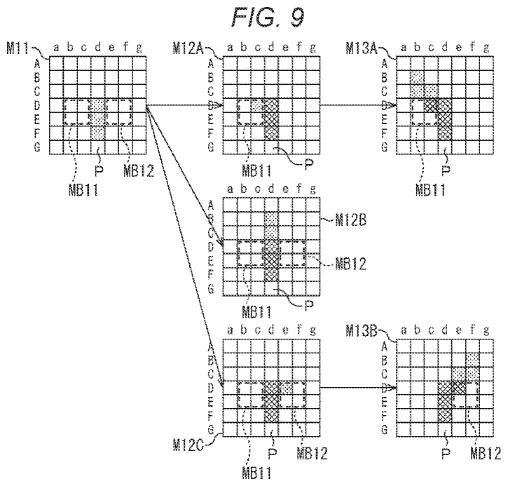

That is, for example, as illustrated in the left part of FIG. 9, a minimum track mask M11 including grids (d, F), (d, E), and (d, C) is set, and the presence or absence of collision with an obstacle on an occupancy grid map is determined.

Then, next, grids (c, D), (d, D), and (e, D) are added to the track mask M11 to set track masks M12A, M12B, and M12C, respectively, and then the presence or absence of collision with an obstacle on the occupancy grid map is determined.

Moreover, grids (c, C), (b, C), and (b, B) are added to the track mask M12A to set a track mask M13A, and similarly, grids (e, C), (f, C), and (f, B) are added to the track mask M12B to set a track mask M13B, and then the presence or absence of collision with an obstacle on the occupancy grid map is determined.

By gradually expanding the track mask from the smallest track mask including all the track candidates in this manner, it is possible to terminate the processing at timing when the track mask without collision disappears at any timing, and it is possible to suppress the amount of calculation in a case where there are many collisions.

For example, in the case of the track masks M12A and M12C, when an obstacle is present in the area MB11 or MB12 on the occupancy grid map, it is also determined that there is collision in the track masks M13A and M13B because an obstacle is present in the area MB11 on the occupancy grid map. Therefore, in a case where it is determined that there is collision in the track masks M12A and M12C, the collision determination for the track mask M13A or M13B becomes unnecessary, so that the calculation can be terminated.

In particular, in a case where collision is expected at a position close to the current position in many of the track candidates, when it is determined that there is collision in the track mask in a range close to the current position, the collision determination becomes unnecessary in the subsequent track masks, so that it is possible to suppress the amount of calculation and to implement rapid collision determination processing.

<Collision Determination Processing (Part 2)>

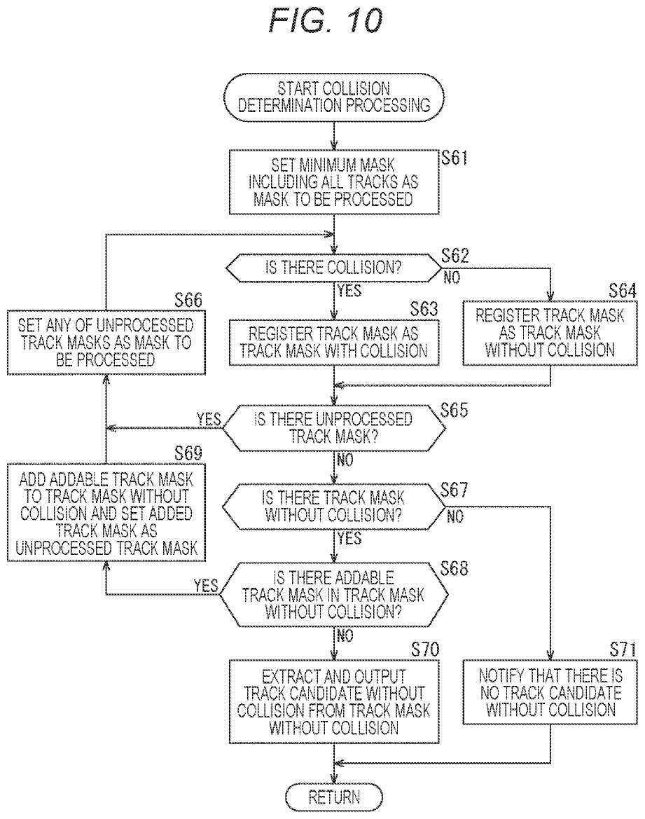

Next, collision determination processing of performing collision determination from the smallest track mask, and repeating the collision determination while gradually expanding the track mask will be described with reference to the flowchart of FIG. 10.

In step S61, a collision determination unit 215 reads the track mask from a track mask storage unit 213, and sets the minimum track mask integrating all of track candidates close to the current position as a track mask to be processed.

In step S62, the collision determination unit 215 superimposes the track mask set as the track mask to be processed on the occupancy grid map, and determines the presence or absence of collision according to whether or not there is an obstacle on the occupancy grid map on the track mask.

In step S62, for example, in the track mask M11 described with reference to FIG. 9, in a case where there is an obstacle and the presence of collision is determined, the processing proceeds to step S63.

In step S63, the collision determination unit 215 registers that the track mask to be processed is in the presence of collision. That is, here, all the track masks are registered as the presence of collision, as indicated by the track mask M11 in FIG. 9.

Furthermore, in step S62, in a case where the absence of collision is determined, the processing proceeds to step S64.

In step S64, the collision determination unit 215 registers that the track mask to be processed is in the absence of collision. That is, here, all the track masks are registered as the absence of collision, as indicated by the track mask M11 in FIG. 9.

In step S65, the collision determination unit 215 determines whether or not there is an unprocessed track mask.

For example, in a case where the track mask to be processed is the track mask M11, since there is no other unprocessed track mask, it is assumed that there is no unprocessed track mask, and the processing proceeds to step S67.

In step S67, the collision determination unit 215 determines whether or not there is a track mask registered with the absence of collision.

In step S67, for example, in the case where the track mask M11 in FIG. 9 is registered as the absence of collision, there is a track mask without collision, and thus the processing proceeds to step S68.

In step S68, the collision determination unit 215 determines whether or not there is an addable track mask in the track mask without collision.

In step S68, for example, the track mask M11 to be processed in FIG. 9 can be changed to the track masks M12A, M12B, and M12C by adding grids (c, D), (d, C), and (b, C), and (e, D) as new track masks. Therefore, it is determined that there are addable track masks, and the processing proceeds to step S69.

In step S69, the collision determination unit 215 generates track masks by adding the new masks to the track mask without collision, and sets the generated track masks as unprocessed track masks.

That is, for example, the collision determination unit 215 adds the new track masks to the track mask M11 to generate the track masks M12A to M12C, and sets the generated track masks M12A to M12C as unprocessed track masks.

In step S66, the collision determination unit 215 sets one of the unprocessed track masks as the track mask to be processed, and the processing returns to step S62.

Then, when the collision determination of the track mask to be processed is performed by the processing in steps S62 to S64, in a case where there is an unprocessed track mask in step S65, the processing returns to step S66 and a new unprocessed track mask is set as the track mask to be processed, and the subsequent processing is repeated.

That is, the processing of steps S62 to S66 is repeated until the presence or absence of collision is determined for all of the unprocessed track masks.

Then, when the presence or absence of collision is determined for all the track masks, the absence of an unprocessed track mask is determined in step S65, and the processing proceeds to step S67.

As long as there is a track mask without collision in step S67 and there is an addable track mask in the track mask without collision in step S68, the processing of steps S62 to S69 is repeated, and the addition of the new track mask and the determination of the presence or absence of collision of the track mask with the new added track mask are repeated.

Then, in step S67, in the case where there is no track mask without collision, the processing proceeds to step S71.

In step S71, the collision determination unit 215 notifies a track evaluation unit 216 that there is no track candidate without collision integrated in the track mask without collision.

Furthermore, in a case where there is a track mask without collision in step S67, but there is no addable track mask in step S68, the processing proceeds to step S70.

In step S70, the collision determination unit 215 outputs the track candidate integrated in the track mask without collision to the track evaluation unit 216.

By the above-described series of processing, the collision determination unit 215 determines the presence or absence of collision in units of track masks in which track candidates are integrated, and thus, it is possible to reduce the amount of calculation and to select a track candidate at a higher speed than the processing of determining collision for each track candidate.

In particular, in a case where there are many track masks with collision, the processing of determining the presence or absence of collision of the subsequent track mask is terminated at a time point when there is no track mask without collision in the track mask close to the current position, so that the amount of calculation can be reduced.

### 4. Third Embodiment

A track mask is formed in a form of a correspondence table in which each grid and a track candidate are associated in a track mask storage unit 213.

Therefore, a map including information for each of grids based on a correspondence table for forming a track mask is generated, and track candidates associated with grids in which no obstacle exists on an occupancy grid map can be regarded as track candidates without collision.

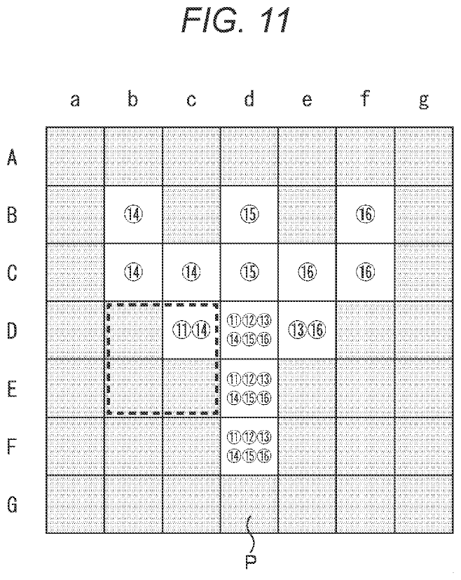

That is, as illustrated in FIG. 11, a map for specifying information of a corresponding track candidate for each grid is formed on the basis of a correspondence table of grids that are information of track masks and track candidates stored in the track mask storage unit 213. Note that the map of FIG. 11 is substantially the same as the correspondence table of FIG. 5.

Then, by superimposing an occupancy grid map on this map, the presence or absence of an obstacle for each grid is confirmed, and collision occurs in the track mask of the grid where the obstacle is present, so that it is specified that collision occurs in the track candidate integrated in the corresponding track mask.

For example, in a case where an obstacle is present in areas of grids (c, D), (c, E), (b, D), and (b, E) surrounded by the dotted line in FIG. 11, collision occurs in track candidates R11 and R14 registered in the grid (c, D) on the track mask.

Therefore, in the case of FIG. 11, track candidates R12, R13, R15, and R16 other than the track candidates R11 and R14 are selected as track candidates without collision.

In this way, it is possible to obtain the track candidates with collision only by obtaining the track candidates registered in association with the track mask of the grid in which an obstacle is present, and it is possible to specify the other track candidates as the track candidate without collision.

As a result, it is possible to specify the track candidates without collision only by the information of grids where an obstacle is present, and thus it is possible to suppress the amount of calculation.

<Collision Determination Processing (Part 3)>

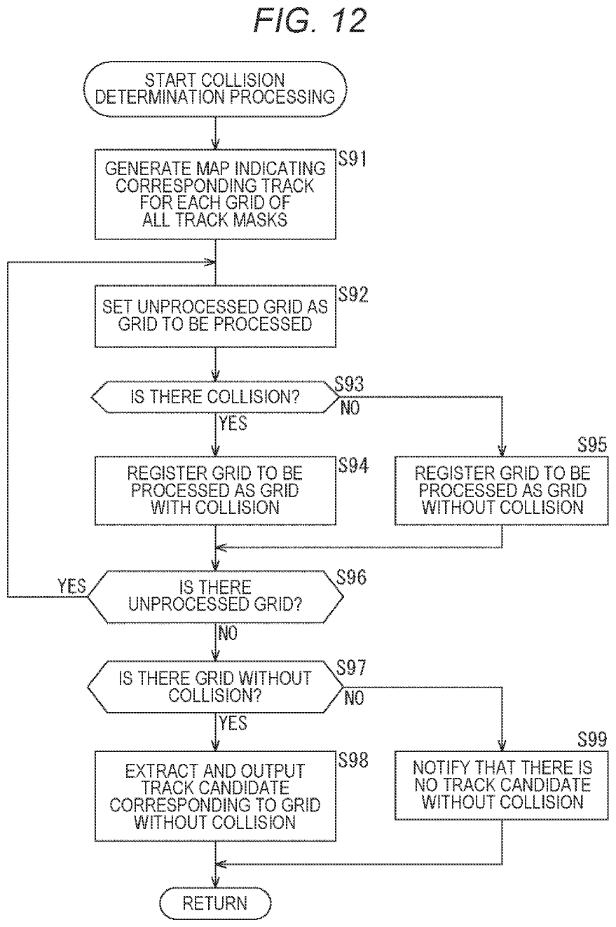

Next, collision determination processing based on the map including the information for each grid based on the correspondence table for forming a track mask will be described with reference to a flowchart of FIG. 12.

In step S91, a collision determination unit 215 reads the information of the correspondence table for specifying a track mask stored in the track mask storage unit 213, and generates the map indicating the correspondence between each grid of a track mask and a track candidate passing through the grid as illustrated in FIG. 11.

In step S92, the collision determination unit 215 sets an unprocessed grid among the grids in the track mask as a grid to be processed.

In step S93, the collision determination unit 215 superimposes the occupancy grid map on the map on the basis of the track mask, and determines the presence or absence of collision on the basis of whether or not the grid to be processed is an area where an obstacle is present.

In step S93, in a case where it is determined that there is an obstacle in the grid to be processed and there is collision, the processing proceeds to step S94.

In step S94, the collision determination unit 215 registers the grid to be processed as the presence of collision.

Furthermore, in step S93, in a case where it is determined that there is no obstacle in the grid to be processed and there is no collision, the processing proceeds to step S95.

In step S95, the collision determination unit 215 registers the grid to be processed as the absence of collision.

In step S96, the collision determination unit 215 determines whether or not there is an unprocessed grid in the map, and in a case where there is an unprocessed grid, the processing returns to step S92.

That is, the processing of steps S92 to S96 is repeated until there is no unprocessed grid, and the presence or absence of collision is determined for all the grids on the track mask.

Then, when the presence or absence of collision is determined for all the grids in step S96, the processing proceeds to step S97.

In step S97, the collision determination unit 215 determines whether or not there is a grid without collision.

In step S97, in a case where it is determined that there is a grid without collision, the processing proceeds to step S98.

In step S98, the collision determination unit 215 outputs all the track candidates excluding the track candidates registered in association with the grid with collision to the track evaluation unit 216 as track candidates without collision.

On the other hand, in step S97, in a case where the absence of grids without collision is determined, the processing proceeds to step S99.

In step S99, the collision determination unit 215 outputs, to the track evaluation unit 216, that there is no track candidate without collision.

As a result, it is possible to specify the track candidates without collision only by the information of grids where an obstacle is present, and thus it is possible to suppress the amount of calculation.

### 5. Example of Executed by Software

By the way, the above-described series of processing can be executed by hardware or software. In a case where the series of processing is executed by software, a program constituting the software is installed from a recording medium into a computer incorporated in special hardware, a general-purpose computer capable of executing various functions by installing various programs, or the like.

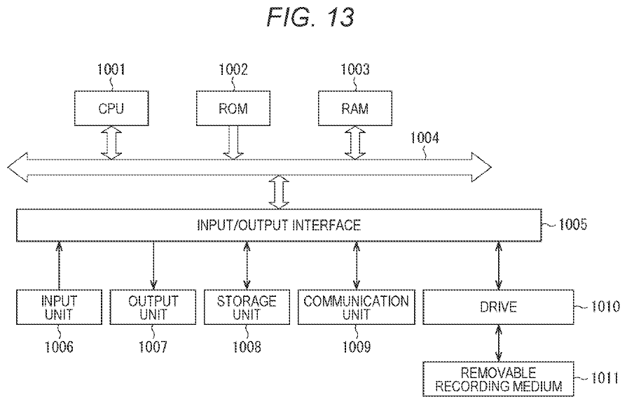

FIG. 13 illustrates a configuration example of a general-purpose computer. The personal computer incorporates a central processing unit (CPU) 1001. An input/output interface 1005 is connected to the CPU 1001 via a bus 1004. A read only memory (ROM) 1002 and a random access memory (RAM) 1003 are connected to the bus 1004.

To the input/output interface 1005, an input unit 1006 including an input device such as a keyboard and a mouse for a user to input operation commands, an output unit 1007 that outputs a processing operation screen and an image of a processing result to a display device, a storage unit 1008 including a hard disk drive for storing programs and various data, and a communication unit 1009 including a local area network (LAN) adapter and the like and which executes communication processing via a network typified by the Internet are connected. Furthermore, a drive 1010 that reads and writes data with respect to a removable medium 1011 such as a magnetic disk (including a flexible disk), an optical disk (including a compact disc-read only memory (CD-ROM) or a digital versatile disc (DVD)), a magneto-optical disk (including a mini disc (MD)), or a semiconductor memory is connected to the input/output interface 1005.

The CPU 1001 executes various types of processing according to a program stored in the ROM 1002 or a program read from the removable medium 1011 such as a magnetic disk, an optical disk, a magneto-optical disk, or a semiconductor memory, installed in the storage unit 1008, and loaded from the storage unit 1008 to the RAM 1003. Furthermore, the RAM 1003 appropriately stores data and the like necessary for the CPU 1001 to execute the various types of processing.

In the computer configured as described above, the CPU 1001, for example, loads the program stored in the storage unit 1008 into the RAM 1003 and executes the program via the input/output interface 1005 and the bus 1004, whereby the above-described series of processing is performed.

The program to be executed by the computer (CPU 1001) can be recorded on the removable medium 1011 as a package medium and the like, for example, and provided. Furthermore, the program can be provided via a wired or wireless transmission medium such as a local area network, the Internet, or digital satellite broadcast.

In the computer, the removable medium 1011 is attached to the drive 1010, whereby the program can be installed in the storage unit 1008 via the input/output interface 1005. Furthermore, the program can be received by the communication unit 1009 via a wired or wireless transmission medium and installed in the storage unit 1008. Other than the above method, the program can be installed in the ROM 1002 or the storage unit 1008 in advance.

Note that the program executed by the computer may be a program processed in chronological order according to the order described in the present specification or may be a program executed in parallel or at necessary timing such as when a call is made.

Note that the CPU 1001 in FIG. 13 implements the function of the automatic driving control unit 112 in FIG. 5. Furthermore, the storage unit 1008 in FIG. 13 implements the storage unit 111 in FIG. 5.

Furthermore, in the present specification, the term “system” means a group of a plurality of configuration elements (devices, modules (parts), and the like), and whether or not all the configuration elements are in the same casing is irrelevant. Therefore, a plurality of devices housed in separate housings and connected via a network, and one device that houses a plurality of modules in one housing are both systems.

Note that the embodiments of the present disclosure are not limited to the above-described embodiments, and various modifications can be made without departing from the gist of the present disclosure.

For example, the present disclosure can adopt a configuration of cloud computing in which one function is shared and processed in cooperation by a plurality of devices via a network.

Furthermore, the steps described in the above-described flowcharts can be executed by one device or can be shared and executed by a plurality of devices.

Moreover, in a case where a plurality of processes is included in one step, the plurality of processes included in the one step can be executed by one device or can be shared and executed by a plurality of devices.

Note that the present disclosure can have the following configurations.

<1> An information processing device including:

a track candidate sampling unit configured to sample a track candidate of a mobile body;

a track mask generation unit configured to integrate a plurality of the track candidates, of the track candidates sampled by the track candidate sampling unit, in association with a grid of an occupancy grid map, and generate a track mask in which the plurality of integrated track candidates and the grid of the occupancy grid map are associated with each other; and

a collision determination unit configured to perform collision determination of the track candidates on the basis of the track mask generated by the track mask generation unit and the occupancy grid map.

<2> The information processing device according to <1>, in which

the collision determination unit performs the collision determination on the basis of presence or absence of an obstacle area on the occupancy grid map on the track mask by superimposing the track mask generated by the track mask generation unit and the occupancy grid map.

<3> The information processing device according to <2>, in which

the collision determination unit performs the collision determination on the basis of presence or absence of an obstacle area on the occupancy grid map on the track mask to be processed by setting all the track masks generated by the track mask generation unit as track masks to be processed and superimposing the occupancy grid map, and

in a case where it is determined that there is a collision, the collision determination unit performs the collision determination on the basis of presence or absence of an obstacle area on the occupancy grid map on the track mask to be processed by subdividing the track mask to be processed to generate a subdivided track mask, setting the subdivided track mask as the track mask to be processed, and superimposing the occupancy grid map.

<4> The information processing device according to <3>, in which

the collision determination is performed on the basis of presence or absence of an obstacle area on the occupancy grid map on the track mask to be processed by superimposing the track mask to be processed and the occupancy grid map, and

in a case where it is determined that there is a collision, the collision determination unit performs the collision determination on the basis of presence or absence of an obstacle area on the occupancy grid map on the track mask to be processed by further subdividing the track mask to be processed to generate a new subdivided track mask, setting the new subdivided track mask as the track mask to be processed, and superimposing the occupancy grid map.

<5> The information processing device according to <4>, in which,

in a case where it is determined that there is a collision, the collision determination unit repeats generating the new track mask to be processed by subdivision, setting the track mask to be processed as the track mask to be processed, and performing the collision determination until it is determined that there is no collision or until the track mask to be processed becomes unable to be subdivided.

<6> The information processing device according to <3>, in which,

in a case where it is determined that there is collision, the collision determination unit performs the collision determination on the basis of presence or absence of an obstacle area on the occupancy grid map on the track mask to be processed by generating, as a new subdivided track mask, a track mask in which track candidates up to a distance close to a current position are integrated among the track candidates integrated into the track mask to be processed, setting the new subdivided track mask as the track mask to be processed, and superimposing the occupancy grid map.

<7> The information processing device according to <2>, in which

the collision determination unit performs the collision determination on the basis of presence or absence of an obstacle area on the occupancy grid map on the track mask to be processed by setting a minimum track mask in which all the track candidates are integrated, among the track masks generated by the track mask generation unit, as the track mask to be processed, and superimposing the occupancy grid map, and

in a case where it is determined that there is no collision, the collision determination unit performs the collision determination on the basis of presence or absence of an obstacle area on the occupancy grid map on the track mask to be processed by generating an additional track mask by adding a grid in which some track candidates are integrated, the grid being adjacent to the track mask to be processed, to the track mask to be processed, setting the additional track mask as the track mask to be processed, and superimposing the occupancy grid map.

<8> The information processing device according to <7>, in which

the collision determination is performed on the basis of presence or absence of an obstacle area on the occupancy grid map on the track mask to be processed by superimposing the track mask to be processed and the occupancy grid map, and

in a case where it is determined that there is no collision, the collision determination unit performs the collision determination on the basis of presence or absence of an obstacle area on the occupancy grid map on the track mask to be processed by generating a new additional track mask by further adding a grid in which another some track candidates are integrated to the track mask to be processed, setting the new additional track mask as the track mask to be processed, and superimposing the occupancy grid map.

<9> The information processing device according to <8>, in which,

in a case where it is determined that there is a collision, the collision determination unit repeats generating a new additional track mask by adding a grid in which another some track candidates are integrated until it is determined that there is no collision or until the new additional track mask becomes unable to be generated, setting the new additional track mask as the track mask to be processed, and performing the collision determination.

<10> The information processing device according to <2>, in which

the track mask generation unit generates, as the track mask, a correspondence table indicating correspondence between the grid constituting the track mask and a track candidate passing through the grid, and

the collision determination unit superimposes a map of the track candidate passing through the grid for the each grid constituting the track mask and the occupancy grid map on the basis of the correspondence table, and performs the collision determination on the basis of presence or absence of an obstacle area of the occupancy grid map on the map.

<11> The information processing device according to <10>, in which

the collision determination unit superimposes the map of the track candidate passing through the grid for the each grid constituting the track mask and the occupancy grid map on the basis of the correspondence table, and performs the collision determination of determining a track candidate passing through the obstacle area on the occupancy grid map on the map as a track candidate with collision and determining a track candidate other than the track candidate with collision as a track candidate without collision.

<12> The information processing device according to any one of <1> to <11>, further including:

a track evaluation unit configured to set an evaluation value for each of the track candidates determined to have no collision on the basis of a collision determination result by the collision determination unit and output the track candidate having the highest evaluation value as a target track.

<13> The information processing device according to any one of <1> to <12>, in which

the track mask generation unit integrates a plurality of track candidates in association with a grid corresponding to a resolution of the obtained occupancy grid map to generate the track mask.

<14> An information processing method including:

track candidate sampling processing of sampling a track candidate of a mobile body;

track mask generation processing of integrating a plurality of the track candidates, of the track candidates sampled by the track candidate sampling processing, in association with a grid of an occupancy grid map, and generating a track mask in which the plurality of integrated track candidates and the grid of the occupancy grid map are associated with each other; and

collision determination processing of performing collision determination of the track candidates on the basis of the track mask generated by the track mask generation processing and the occupancy grid map.

<15> A program for causing a computer to function as:

a track candidate sampling unit configured to sample a track candidate of a mobile body;

a track mask generation unit configured to integrate a plurality of the track candidates, of the track candidates sampled by the track candidate sampling unit, in association with a grid of an occupancy grid map, and generate a track mask in which the plurality of integrated track candidates and the grid of the occupancy grid map are associated with each other; and

a collision determination unit configured to perform collision determination of the track candidates on the basis of the track mask generated by the track mask generation unit and the occupancy grid map.

### REFERENCE SIGNS LIST

91 Vehicle
100 Vehicle control system
102 Data acquisition unit
106 Output unit
111 Storage unit
112 Automatic driving control unit
131 Detection unit
132 Self-position estimation unit
133 Situation analysis unit
134 Planning unit
135 Operation control unit
141 Vehicle exterior information detection unit
151 Map analysis unit
152 Traffic rule recognition unit
153 Situation recognition unit
154 Situation prediction unit
181 Track planning unit
211 Track candidate sampling unit
212 Track mask generation unit
213 Track mask storage unit
214 Occupancy grid map adjustment unit
215 Collision determination unit
216 Track evaluation unit

1. An information processing device comprising:
a track candidate sampling unit configured to sample a track candidate of a mobile body;
a track mask generation unit configured to integrate a plurality of the track candidates, of the track candidates sampled by the track candidate sampling unit, in association with a grid of an occupancy grid map, and generate a track mask in which the plurality of integrated track candidates and the grid of the occupancy grid map are associated with each other; and
a collision determination unit configured to perform collision determination of the track candidates on a basis of the track mask generated by the track mask generation unit and the occupancy grid map.

2. The information processing device according to claim 1, wherein
the collision determination unit performs the collision determination on a basis of presence or absence of an obstacle area on the occupancy grid map on the track mask by superimposing the track mask generated by the track mask generation unit and the occupancy grid map.

3. The information processing device according to claim 2, wherein
the collision determination unit performs the collision determination on a basis of presence or absence of an obstacle area on the occupancy grid map on the track mask to be processed by setting all the track masks generated by the track mask generation unit as track masks to be processed and superimposing the occupancy grid map, and
in a case where it is determined that there is a collision, the collision determination unit performs the collision determination on a basis of presence or absence of an obstacle area on the occupancy grid map on the track mask to be processed by subdividing the track mask to be processed to generate a subdivided track mask, setting the subdivided track mask as the track mask to be processed, and superimposing the occupancy grid map.

4. The information processing device according to claim 3, wherein
the collision determination is performed on a basis of presence or absence of an obstacle area on the occupancy grid map on the track mask to be processed by superimposing the track mask to be processed and the occupancy grid map, and
in a case where it is determined that there is a collision, the collision determination unit performs the collision determination on a basis of presence or absence of an obstacle area on the occupancy grid map on the track mask to be processed by further subdividing the track mask to be processed to generate a new subdivided track mask, setting the new subdivided track mask as the track mask to be processed, and superimposing the occupancy grid map.

5. The information processing device according to claim 4, wherein,
in a case where it is determined that there is a collision, the collision determination unit repeats generating the new track mask to be processed by subdivision, setting the track mask to be processed as the track mask to be processed, and performing the collision determination until it is determined that there is no collision or until the track mask to be processed becomes unable to be subdivided.

6. The information processing device according to claim 3, wherein,
in a case where it is determined that there is collision, the collision determination unit performs the collision determination on a basis of presence or absence of an obstacle area on the occupancy grid map on the track mask to be processed by generating, as a new subdivided track mask, a track mask in which track candidates up to a distance close to a current position are integrated among the track candidates integrated into the track mask to be processed, setting the new subdivided track mask as the track mask to be processed, and superimposing the occupancy grid map.

7. The information processing device according to claim 2, wherein
the collision determination unit performs the collision determination on a basis of presence or absence of an obstacle area on the occupancy grid map on the track mask to be processed by setting a minimum track mask in which all the track candidates are integrated, among the track masks generated by the track mask generation unit, as the track mask to be processed, and superimposing the occupancy grid map, and
in a case where it is determined that there is no collision, the collision determination unit performs the collision determination on a basis of presence or absence of an obstacle area on the occupancy grid map on the track mask to be processed by generating an additional track mask by adding a grid in which some track candidates are integrated, the grid being adjacent to the track mask to be processed, to the track mask to be processed, setting the additional track mask as the track mask to be processed, and superimposing the occupancy grid map.

8. The information processing device according to claim 7, wherein
the collision determination is performed on a basis of presence or absence of an obstacle area on the occupancy grid map on the track mask to be processed by superimposing the track mask to be processed and the occupancy grid map, and
in a case where it is determined that there is no collision, the collision determination unit performs the collision determination on a basis of presence or absence of an obstacle area on the occupancy grid map on the track mask to be processed by generating a new additional track mask by further adding a grid in which another some track candidates are integrated to the track mask to be processed, setting the new additional track mask as the track mask to be processed, and superimposing the occupancy grid map.

9. The information processing device according to claim 8, wherein,
in a case where it is determined that there is a collision, the collision determination unit repeats generating a new additional track mask by adding a grid in which another some track candidates are integrated until it is determined that there is no collision or until the new additional track mask becomes unable to be generated, setting the new additional track mask as the track mask to be processed, and performing the collision determination.

10. The information processing device according to claim 2, wherein
the track mask generation unit generates, as the track mask, a correspondence table indicating correspondence between the grid constituting the track mask and a track candidate passing through the grid, and
the collision determination unit superimposes a map of the track candidate passing through the grid for the each grid constituting the track mask and the occupancy grid map on a basis of the correspondence table, and performs the collision determination on a basis of presence or absence of an obstacle area of the occupancy grid map on the map.

11. The information processing device according to claim 10, wherein
the collision determination unit superimposes the map of the track candidate passing through the grid for the each grid constituting the track mask and the occupancy grid map on a basis of the correspondence table, and performs the collision determination of determining a track candidate passing through the obstacle area on the occupancy grid map on the map as a track candidate with collision and determining a track candidate other than the track candidate with collision as a track candidate without collision.

12. The information processing device according to claim 1, further comprising:
a track evaluation unit configured to set an evaluation value for each of the track candidates determined to have no collision on a basis of a collision determination result by the collision determination unit and output the track candidate having the highest evaluation value as a target track.

13. The information processing device according to claim 1, wherein
the track mask generation unit integrates a plurality of track candidates in association with a grid corresponding to a resolution of the obtained occupancy grid map to generate the track mask.

14. An information processing method comprising:
track candidate sampling processing of sampling a track candidate of a mobile body;
track mask generation processing of integrating a plurality of the track candidates, of the track candidates sampled by the track candidate sampling processing, in association with a grid of an occupancy grid map, and generating a track mask in which the plurality of integrated track candidates and the grid of the occupancy grid map are associated with each other; and
collision determination processing of performing collision determination of the track candidates on a basis of the track mask generated by the track mask generation processing and the occupancy grid map.

15. A program for causing a computer to function as:
a track candidate sampling unit configured to sample a track candidate of a mobile body;
a track mask generation unit configured to integrate a plurality of the track candidates, of the track candidates sampled by the track candidate sampling unit, in association with a grid of an occupancy grid map, and generate a track mask in which the plurality of integrated track candidates and the grid of the occupancy grid map are associated with each other; and
a collision determination unit configured to perform collision determination of the track candidates on a basis of the track mask generated by the track mask generation unit and the occupancy grid map.
